(19) United States
(12) Patent Application Publication
(10) Pub. No.: US 2005/0013503 A1
(43) Pub. Date: Jan. 20, 2005

(54) Apparatus for image enhancement and method of using the same

(75) Inventors: Yung-jun Park, Yongin-si (KR); Jae-hwan Oh, Suwon-si (KR); Hyun Kang, Suwon-si (KR); Seung-joon Yang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/891,088

(22) Filed: Jul. 15, 2004

(30) Foreign Application Priority Data
Jul. 15, 2003 (KR) 2003-48464

(51) Int. Cl. G06K 9/00; G06K 9/40

(52) U.S. Cl. 382/254; 382/168

(57) ABSTRACT

An image enhancing apparatus and method in which a PDF calculation unit calculates a probability density function according to a distribution of a luminance value with respect to each pixel of an input image. An average brightness calculation unit calculates average brightness of the input image based on the probability density function and an overflow threshold adaptive to the average brightness is calculated. A BUBO unit calculates a probability density function of which a distribution is adjusted, based on the overflow threshold and a predetermined underflow threshold and a cumulative distribution function is calculated with respect to the adjusted probability density function. A CDF compensating unit compensates for an influence that the BUBO unit has on the cumulative distribution function and a mapping unit uses the compensated cumulative distribution function as a mapping function, and adjusts and outputs the luminance value with respect to each pixel of the input image.

### CROSS-REFERENCE TO RELATED APPLICATIONS

This application claims priority from Korean Patent Application No. 2003-48464, filed Jul. 15, 2003 in the Korean Intellectual Property Office, the disclosure of which is incorporated herein by reference for its entirety.

### BACKGROUND OF THE INVENTION

1. Field of the Invention

The present invention relates to an apparatus for image enhancement and a method of using the same, and more specifically, to an apparatus for image enhancement and a method of using the same capable of enhancing image quality by adaptively increasing a gradation display of dark or bright area according to an average brightness of an input image.

2. Description of the Related Art

According to development of technology, a display apparatus has been introduced using new technologies such as an organic electroluminescence (OEL), an electronic paper, a plasma display panel (PDP), and a thin film transistor liquid crystal display (TFT-LCD). An aim of these advanced displays is to make a total thickness of the display very thin and to reproduce a vivid image as if seen in-person. Accordingly, in order to reproduce the vivid image on the display apparatus, several image processing algorithms are used.

However, if such image processing algorithms are applied to the display having a panel which is inferior to a cathode ray tube (CRT) with respect to a gradation display of the dark image like a TV using digital light processing (DLP) technology, the dark image may not be displayed clearly. This darkened display deteriorates in cases where a black/white level stretch algorithm is applied.

To solve the darkened display problem mentioned above, an automatic beam limiter (ABL) circuit may be added. The ABL circuit is used to maintain a steady brightness suitable for high performance image processing. For example, as for the CRT, a brightness of a screen varies in proportion to a quantity of a beam flowing in the CRT. If the beam greater than a predetermined level flows in the CRT, the brightness becomes saturated and a life-span of the CRT is shortened. If a beam flows that is less than the predetermined level, a recognition ability of the image reproduced to the CRT is deteriorated. To prevent this, the ABL circuit should be applied to control the overflow or underflow of the beam. That is, in case of the underflow in which the recognition ability of the reproduced image is deteriorated, a mapping function as shown in FIG. 1A is used to increase a quantity and a luminance of the beam. On the contrary, in case of an overflow, a mapping function as shown in FIG. 1B is used to adjust a power capacity so as to protect the CRT and to enhance the image recognition ability.

However, the conventional method for adjusting the brightness of the dark or white area on the screen has a disadvantage that it is difficult to manufacture the thin display apparatus, due to a requirement for additional hardware, such as the ABL circuit. In addition, a fixed mapping function is used without consideration of the average brightness of the input image. Accordingly, there is another disadvantage that a dynamic range for the gradation display may be reduced in processing a high definition image.

### SUMMARY OF THE INVENTION

The present invention has been made to solve the above disadvantages, and an aspect is to provide an image enhancing apparatus capable of enhancing the image by adaptively improving a gradation display according to an average brightness of an input image without requiring an additional ABL circuit, and a method of using the same.

To achieve the above aspect, the image enhancing apparatus according to an embodiment of the present invention comprises a PDF calculation unit for calculating a probability density function according to a distribution of a luminance value of each pixel of an input image, an average brightness calculation unit for calculating an average brightness of the input image based on the probability density function, an adaptive overflow threshold calculation unit for calculating an overflow threshold adaptive to the average brightness, a BUBO (Bin Underflow Bin Overflow) unit for calculating a probability density function of adjusted distribution, based on the overflow threshold and a predetermined underflow threshold, a CDF calculation unit for calculating a cumulative distribution function with respect to the adjusted probability density function, a CDF compensating unit for compensating for an influence that the BUBO unit has on the cumulative distribution function in calculating the adjusted probability density function, and a mapping unit for using the compensated cumulative distribution function as a mapping function, adjusting and outputting the luminance value with respect to each pixel of the input image.

The BUBO unit calculates the overflow threshold using a predetermined first scale factor in accordance with the following formulas:

$$th\_o [ k ] = [ 1 + ( 128 - mean ) \times \frac{sf1}{128} ] \times th\_o \_low , for k < th\_low$$

th_o[k]=th_o_high, for k≧th_low
wherein, ‘sf1’ denotes the first scale factor and ‘mean’ denotes the average brightness.

In order to adjust the probability density function, the BUBO unit removes a value exceeding the overflow threshold and sets a value less than the underflow threshold to the underflow threshold.

The CDF compensation unit compensates for the cumulative distribution function in accordance with the following formula:

$$\begin{matrix}cdf [ k ] = \frac{( N - 1 )}{cdf [ N - 1 ]} \times cdf [ N ] , or \\ cdf [ k ] = [ cdf [ k ] - \frac{cdf [ N - 1 ]}{[ N - 1 ]} ] + C \cdot k\end{matrix}$$

wherein ‘C’ denotes the number of the entire pixel divided by ‘N−1’.

Preferably, the image enhancing apparatus further comprises an adaptive gain calculation unit for calculating a predetermined gain value. The CDF compensation unit compensates for the cumulative distribution function using the predetermined gain value in accordance with the following formula:

$$cdf [ k ] = gain \times [ cdf [ k ] - \frac{{cdf ( N - 1 )}^{*} k}{( N - 1 )} ] + k$$

The adaptive gain calculation unit calculates the gain value in accordance with the following formula:

$$gain = [ 1 + ( 128 - mean ) \times \frac{sf2}{128} ] \times reg\_gain$$

wherein, ‘sf2’ denotes a second scale factor and ‘reg_gain’ denotes a predetermined setting value regarding the gain. An input unit is further comprised, which is inputted with the first and second scale factors by the user.

A method for enhancing an image according to an embodiment of the present invention comprises the steps of calculating a probability density function according to a distribution of a luminance value of each pixel of an input image, calculating an average brightness of the input image based on the probability density function, calculating an overflow threshold adaptive to the average brightness, calculating a probability density function of adjusted distribution, based on the overflow threshold and a predetermined underflow threshold, calculating a cumulative distribution function with respect to the adjusted probability density function, compensating for an influence that the BUBO unit has on the cumulative distribution function in calculating the adjusted probability density function, calculating the compensated cumulative distribution function, using the compensated cumulative distribution function as a mapping function, and adjusting and calculating the luminance value with respect to each pixel of the input image.

In the step of calculating the adaptive overflow threshold, the overflow threshold is calculated using a predetermined first scale factor in accordance with the following formulas:

$$th\_o [ k ] = [ 1 + ( 128 - mean ) \times \frac{sf1}{128} ] \times th\_o \_low , for k < th\_low$$

th_o[k]=th_o_high, for k≧th_low
wherein, ‘sf1’ denotes the first scale factor and ‘mean’ denotes the average brightness.

In the step of calculating the adaptive overflow threshold, the probability density function is adjusted in such a manner that a value exceeding the overflow threshold is removed and a value less than the underflow threshold is set to the underflow threshold.

In the step of calculating the compensated cumulative distribution function, the cumulative distribution function is compensated in accordance with the following formulas:

$$\begin{matrix}cdf [ k ] = \frac{( N - 1 )}{cdf [ N - 1 ]} \times cdf [ N ] , or \\ cdf [ k ] = [ cdf [ k ] - \frac{cdf [ N - 1 ]}{[ N - 1 ]} ] + C \cdot k\end{matrix}$$

wherein, ‘C’ denotes the number of the entire pixel divided by ‘N−1’.

According to a further embodiment, calculating a predetermined gain value is also performed. In the step of calculating the compensated cumulative distribution function, the cumulative distribution function is compensated using the predetermined gain value in accordance with the following formula:

$$cdf [ k ] = gain \times [ cdf [ k ] - \frac{{cdf ( N - 1 )}^{*} k}{( N - 1 )} ] + k$$

In the step of calculating the gain value, the gain value is calculated in accordance with the following formula:

$$gain = [ 1 + ( 128 - mean ) \times \frac{sf2}{128} ] \times reg\_gain$$

wherein, ‘sf2’ denotes the second scale factor and ‘reg_gain’ denotes a predetermined setting value with respect to the gain. Also, the method further comprises the step of inputting the first and second scale factors by the user.

### BRIEF DESCRIPTION OF THE DRAWING FIGURES

The above aspects, and/or other features and advantages of the present invention will become more apparent after a reading of the following detailed description when taken in conjunction with the drawing figures, in which:

FIGS. 1A and 1B are examples of a mapping function used for a conventional ABL circuit;

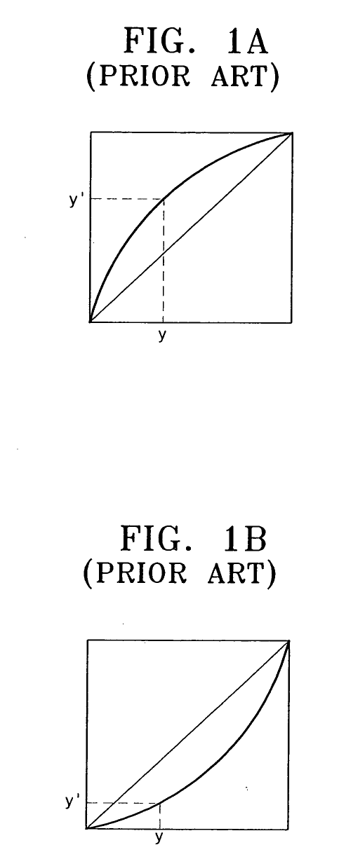

FIG. 2 is a block diagram of an image enhancing apparatus according to an embodiment of the present invention;

FIG. 3 is a flow chart of an operation of an image enhancing apparatus according to an embodiment of the present invention;

FIGS. 4A and 4B are graphs illustrating an operation of a BUBO unit; and

FIGS. 5A and 5B are graphs illustrating a CDF compensation process.

### DETAILED DESCRIPTION OF AN EXEMPLARY EMBODIMENT

Reference will now be made in detail to an embodiment of the present invention, examples of which are illustrated in the accompanying drawing figures, wherein like reference numerals refer to like elements throughout. The embodiments are described to explain the present invention by referring to the drawing figures.

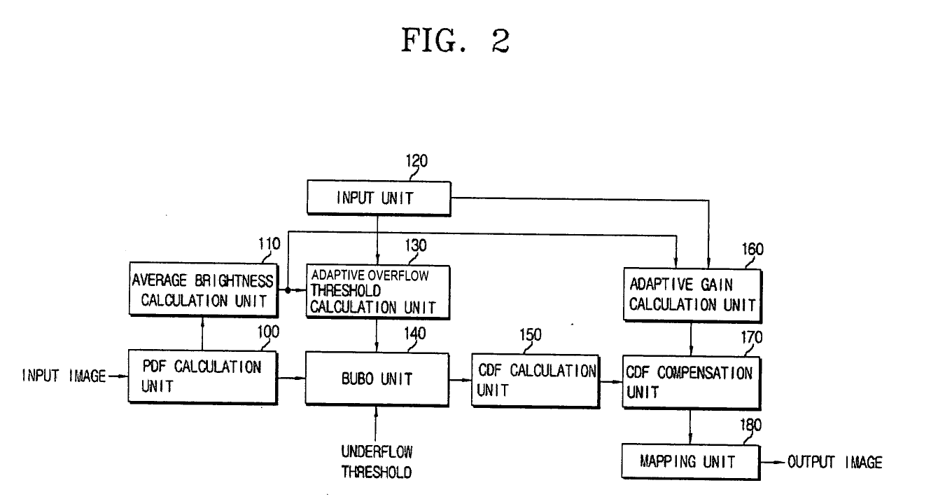

FIG. 2 is a block diagram of an image enhancing apparatus according to an embodiment of the present invention. Referring to FIG. 2, the image enhancing apparatus comprises a PDF calculation unit 100, an average brightness calculation unit 110, an input unit 120, an adaptive overflow threshold calculation unit 130, a BUBO unit 140, a CDF calculation unit 150, an adaptive gain calculation unit 160, a CDF compensation unit 170 and a mapping unit 180.

The PDF calculation unit 100 detects a luminance value of each pixel forming an input image and calculates a probability density function (hereinafter, referred to as “PDF”) based on the detected luminance value. The PDF indicates a rate that an irregular signal has a certain value.

The average brightness calculation unit 110 calculates an average brightness of the input image using the PDF that is calculated in the PDF calculation unit 100. The input unit 120 is inputted with a scale factor used for the calculation of an overflow threshold and a gain by a user, which will be described later. The adaptive overflow threshold calculation unit 130 analyzes the average brightness of the input image and calculates the overflow threshold adaptively. The BUBO unit 140 adjusts the PDF which is calculated using the overflow threshold and a predetermined underflow threshold. The CDF calculation unit 150 calculates a cumulative distribution function (hereinafter, referred to as “CDF”) using the adjusted PDF. The adaptive gain calculation unit 160 calculates a gain to be used for compensation in the CDF compensation unit 170. The CDF compensation unit 170 compensates for an influence that the BUBO unit 140 has on the CDF according to the PDF adjustment. The mapping unit 180 enhances the image by adjusting a pixel value of the input image by using the compensated CDF in the CDF compensation unit 170 as a mapping function.

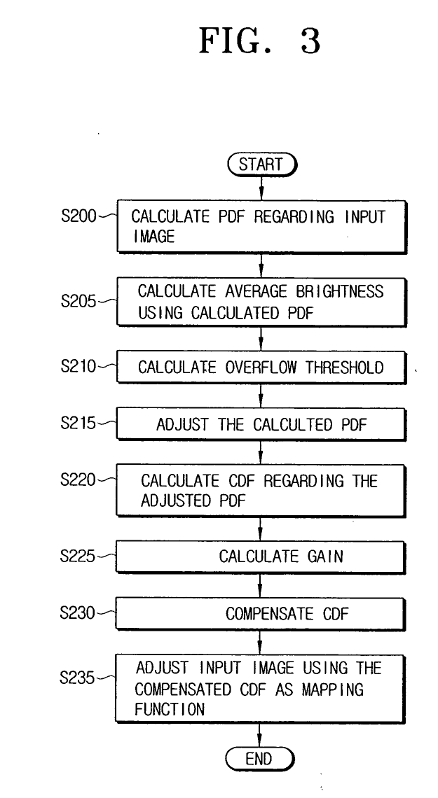

FIG. 3 is a flowchart of an operation of an image enhancing apparatus according to an embodiment of the present invention. Referring to FIGS. 2 and 3, the operation of the image enhancing apparatus is described. First, the PDF calculation unit 100 calculates the PDF regarding the input image (S200). The PDF is calculated in such a manner that the luminance value of each pixel forming the input image is detected and the number of the pixel is counted that corresponds to each luminance value within the luminance value of the detected pixel. After the PDF of the input image is calculated, the average brightness calculation unit 110 calculates the average brightness of the input image based on the calculated PDF (S205).

The adaptive overflow threshold calculation unit 130 uses the average brightness calculated in the average brightness calculation unit 110 and a first scale factor inputted by the user through the input unit 120 so as to calculate the variable overflow threshold in accordance with the following formula 1 (S210):

$$th\_o [ k ] = [ 1 + ( 128 - mean ) \times \frac{sf1}{128} ] \times th\_o \_low , for k < th\_low \\ th\_o [ k ] = th\_o \_high , for k \geq th\_low \qquad ( 1 )$$

wherein, ‘mean’ denotes the average brightness of the input image, ‘sf1’ denotes the first scale factor, ‘th_o_high’ denotes the fixed overflow threshold and ‘th_low’ denotes a reference value for dividing the PDF of the input image into the dark area (or the light area) and the intermediate area.

The BUBO unit 140 detects the overflow and the underflow, using the calculated overflow threshold and the predetermined underflow threshold, which is determined experimentally, and accordingly adjusts the calculated PDF (S215). That is, the BUBO unit 140 uses the calculated overflow threshold and the predetermined underflow threshold so as to detect the overflow and the underflow from the calculated PDF in accordance with the following formula 2:
if pdf[k]<th_u then underflow
if pdf[k]>th_o[k] then overflow (2)
wherein, ‘th_u’ denotes the underflow threshold.

Upon detecting the overflow and the underflow, the BUBO unit 140 removes values in the calculated PDF that exceed the overflow threshold and adjusts values less than the underflow threshold to the underflow threshold in accordance with the following formula 3:
pdf[k]=th_u, in case of the underflow
pdf[k]=th_o[k], in case of the overflow
pdf[k]=pdf[k], in case of the rest (3)

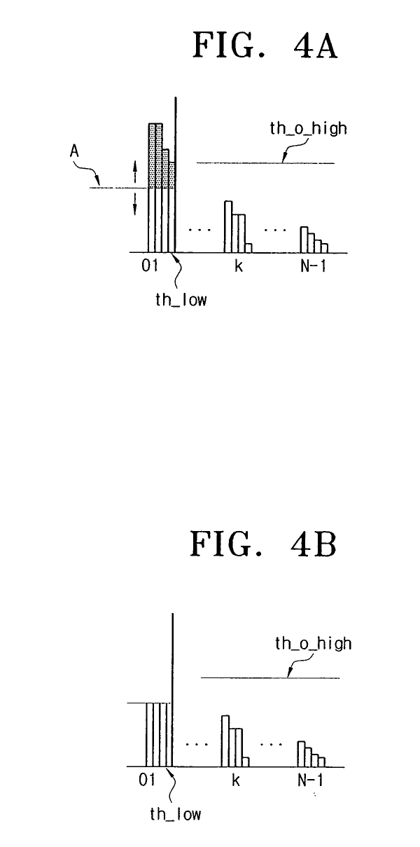

FIGS. 4A and 4B are graphs illustrating an operation that the PDF is adjusted in the BUBO unit 140 using the calculated overflow threshold. Referring to FIG. 4A, ‘A’ indicates the overflow threshold, and the shaded areas indicate the values exceeding the overflow threshold. FIG. 4B shows the PDF after having removed the values exceeding the overflow threshold. Though FIGS. 4A and 4B show only the values exceeding the overflow threshold for convenience, the values less than the underflow threshold may be set equal to the underflow threshold through the method described above.

After the PDF is adjusted, the CDF calculation unit 150 calculates the CDF with respect to the adjusted PDF in accordance with the following formula 4 (S220):

$$cdf [ k ] = {\sum }_{i = 0}^{k} pdf [ t ] \qquad ( 4 )$$

The adaptive gain calculation unit 160 calculates the gain in accordance with the following formula 5 (S225):

$$gain = [ 1 + ( 128 - mean ) \times \frac{sf2}{128} ] \times reg\_gain \qquad ( 5 )$$

wherein, ‘reg_gain’ denotes a resistor setting value with respect to the gain, and ‘sf2’ denotes a second scale factor.

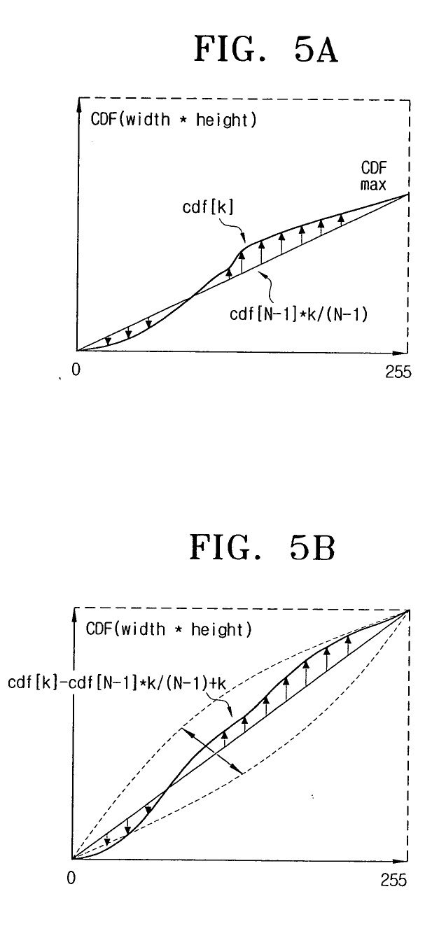

The CDF compensation unit 170 compensates for the influence that the BUBO unit 140 has on the CDF according to the PDF adjustment. At this time, the compensation is performed basically using the following formulas 6, and FIG. 5A explains the formulas.

$$cdf [ k ] = [ cdf [ k ] - \frac{cdf [ N - 1 ]}{[ N - 1 ]} ] + C \cdot k \\ cdf [ k ] = \frac{( N - 1 )}{cdf [ N - 1 ]} \times cdf [ N ] \qquad ( 6 )$$

wherein, ‘C’ denotes the number of the entire pixel divided by ‘N-l’.

For example, referring to equation 4 above, if the luminance value of each pixel of the input image ranges from 0 to 255, N−1=255. Further, if the luminance value of each pixel of the input image ranges from 0 to 255, ‘k’ of cdf(k), and pdf(k), becomes a value between 0 and 255. Alternatively, referring to equation 6, if the luminance value of each pixel of the input image ranges from 0 to 255, N=256 and C=the total number of pixels/255.

As another embodiment having the same effect as with the ABL circuit, in compensating for the influence on the CDF from the BUBO unit 140, a line ‘k’ may be figured with a line adaptive to the average brightness of the input image or a non-linear function. For example, in adding a difference between the CDF and a line drawn from an origin to a maximum value, to a line fitted for a normal scale, the line fitted for the normal scale may be figured with the non-linear function adaptive to the average brightness of the input image. Alternatively, the non-linear function may be used by being approximated to the line. In the two formulas of the formula 6, used in the CDF compensation unit 170, the former formula may be added to the gain calculated in the adaptive gain calculation unit 160 in order to increase the difference between the line and the CDF, as shown in formula 7 and FIG. 5B.

$$cdf [ k ] = gain \times [ cdf [ k ] - \frac{cdf ( N - 1 ) * k}{( N - 1 )} ] + k \qquad ( 7 )$$

The mapping unit 180 uses the compensated CDF as the mapping function and adjusts the input image (S235) in accordance with the following formula 8:
g(i, j)=CDF[f(i, j)] (8)
wherein, ‘g(i, j)’ denotes an output image, and ‘f(i, j)’ denotes the input image.

According to the above method, the image is enhanced by adaptively improving the gradation display of the dark area in accordance with the input image signal. In one embodiment, even though the dark area, i.e., a black area is taken as the example, the method can be also applied to a white area. Hence, it is also possible to enhance the image by improving the gradation display of the white area in the input image.

As aforementioned, the method according to an embodiment of the present invention is capable of enhancing the image by adaptively improving the gradation display of the dark or light area according to the input image. Also, an ABL circuit is not additionally used, thereby reducing the manufacturing cost and the size of the display apparatus.

While exemplary embodiments of the present invention have been described, additional variations and modifications in those embodiments may occur to those skilled in the art once they learn of the basic inventive concepts. Therefore, it is intended that the appended claims shall be construed to include both the exemplary embodiments described and all such variations and modifications as fall within the spirit and scope of the invention.

1. An image improving apparatus comprising:
a PDF calculation unit operable to calculate a probability density function according to a distribution of a luminance value of each pixel of an input image;
an average brightness calculation unit operable to calculate an average brightness of the input image based on the probability density function;
an adaptive overflow threshold calculation unit operable to calculate an overflow threshold adaptive to the average brightness;
a BUBO unit operable to calculate a probability density function of adjusted distribution, based on the overflow threshold and a predetermined underflow threshold;
a CDF calculation unit operable to calculate a cumulative distribution function with respect to the adjusted probability density function;
a CDF compensating unit operable to compensate for an influence that the BUBO unit has on the cumulative distribution function in calculating the adjusted probability density function; and
a mapping unit operable to use the compensated cumulative distribution function as a mapping function, and adjust and output the luminance value with respect to each pixel of the input image.

2. The apparatus of claim 1, wherein the BUBO unit further uses a predetermined first scale factor in calculating the overflow threshold.

3. The apparatus of claim 2, wherein the BUBO unit calculates the overflow threshold in accordance with the following formulas:
$$th\_o [ k ] = [ 1 + ( 128 - mean ) \times \frac{sf1}{128} ] \times th\_o \_low , for k < th\_low$$
th_o[k]=th_o_high, for k>th_low
wherein, ‘sf1’ denotes the first scale factor and ‘mean’ denotes the average brightness.

4. The apparatus of claim 3, further comprising an input unit operable to receive the first scale factor from a user.

5. The apparatus of claim 1, wherein, in order to adjust the probability density function, the BUBO unit is operable to remove a value exceeding the overflow threshold and set a value less than the underflow threshold to the underflow threshold.

6. The apparatus of claim 1, wherein the CDF compensation unit compensates for the cumulative distribution function in accordance with the following formula:
$$cdf [ k ] = \frac{( N - 1 )}{cdf [ N - 1 ]} \times cdf [ N ] .$$

7. The apparatus of claim 1, wherein the CDF compensation unit compensates for the cumulative distribution function in accordance with the following formula:
$$cdf [ k ] = [ cdf [ k ] - \frac{cdf [ N - 1 ]}{[ N - 1 ]} ] + C \cdot k$$
wherein ‘C’ denotes the number of the entire pixel divided by ‘N−1’.

8. The apparatus of claim 1, further comprising an adaptive gain calculation unit to calculate a predetermined gain value, and
the CDF compensation unit is operable to compensate for the cumulative distribution function using the predetermined gain value in accordance with the following formula:
$$cdf [ k ] = gain \times [ cdf [ k ] - \frac{cdf ( N - 1 ) * k}{( N - 1 )} ] + k .$$

9. The apparatus of claim 8, wherein the adaptive gain calculation unit is operable to calculate the gain value in accordance with the following formula:
$$gain = [ 1 + ( 128 - mean ) \times \frac{sf2}{128} ] \times reg\_gain$$
wherein, ‘sf2’ denotes a second scale factor and ‘reg_gain’ denotes a predetermined setting value regarding the gain.

10. The apparatus of claim 9, further comprising an input unit operable to receive the second scale factor from the user.

11. A method of enhancing an image comprising:
calculating a probability density function according to a distribution of a luminance value of each pixel of an input image;
calculating an average brightness of the input image based on probability density function;
calculating an overflow threshold adaptive to the average brightness;
calculating a probability density function of adjusted distribution, based on the overflow threshold and a predetermined underflow threshold;
calculating a cumulative distribution function with respect to the adjusted probability density function;
compensating for an influence that the BUBO unit has on the cumulative distribution function in calculating the adjusted probability density function, and calculating the compensated cumulative distribution function; and
using the compensated cumulative distribution function as a mapping function, adjusting and calculating the luminance value with respect to each pixel of the input image.

12. The method of claim 11, wherein, in the step of calculating the adaptive overflow threshold, a predetermined first scale factor is further used.

13. The method of claim 12, wherein, in the step of calculating the adaptive overflow threshold, the overflow threshold is calculated in accordance with the following formula:
$$th\_o [ k ] = [ 1 + ( 128 - mean ) \times \frac{sf1}{128} ] \times th\_o \_low , for k < th\_low$$
th_o[k]=th_o_high, for k>th _low
wherein, ‘sf1’ denotes the first scale factor and ‘mean’ denotes the average brightness.

14. The method of claim 13, further comprising the step of receiving the first scale factor from a user.

15. The method of claim 11, wherein, in the step of calculating the adaptive overflow threshold, the probability density function is adjusted in such a manner that a value exceeding the overflow threshold is removed and a value less than the underflow threshold is set to the underflow threshold.

16. The method of 11, wherein, in the step of calculating the compensated cumulative distribution function, the cumulative distribution function is compensated in accordance with the following formula:
$$cdf [ k ] = \frac{( N - 1 )}{cdf [ N - 1 ]} \times cdf [ N ] .$$

17. The method of claim 11, wherein, in the step of calculating the compensated cumulative distribution function, the cumulative distribution function is compensated in accordance with the following formula:
$$cdf [ k ] = [ cdf [ k ] - \frac{cdf [ N - 1 ]}{[ N - 1 ]} ] + C \cdot k$$
wherein, ‘C’ denotes the number of the entire pixel divided by ‘N−1’.

18. The method of claim 11, further comprising the step of calculating a predetermined gain value, and wherein in the step of calculating the compensated cumulative distribution function, the cumulative distribution function is compensated using the predetermined gain value in accordance with the following formula:
$$cdf [ k ] = gain \times [ cdf [ k ] - \frac{cdf ( n - 1 ) * k}{( n - 1 )} ] + k .$$

19. The method of claim 18, wherein, in the step of calculating the gain value, the gain value is calculated in accordance with the following formula:
$$gain = [ 1 + ( 128 - mean ) \times \frac{sf2}{128} ] \times reg\_gain$$
wherein, ‘sf2’ denotes the second scale factor and ‘reg_gain’ denotes a predetermined setting value with respect to the gain.

20. The method of claim 19, further comprising the step of receiving the second scale factor from a user.
